(19) United States
(12) Patent Application Publication
(10) Pub. No.: US 2026/0008408 A1
(43) Pub. Date: Jan. 8, 2026

(54) VEHICULAR ROAD SURFACE DRAWING DEVICE

(71) Applicant: TOYOTA JIDOSHA KABUSHIKI KAISHA, Toyota-shi (JP)

(72) Inventors: Katsutoshi TSUZUKI, Nagoya-shi (JP); Kento NAKAZATO, Tokyo (JP)

(73) Assignee: TOYOTA JIDOSHA KABUSHIKI KAISHA, Toyota-shi (JP)

(21) Appl. No.: 19/043,767

(22) Filed: Feb. 3, 2025

(30) Foreign Application Priority Data
Jul. 4, 2024 (JP) 2024-108374

(51) Int. Cl. B60Q 1/38; H04N 9/31

(52) U.S. Cl. CPC B60Q 1/38; H04N 9/3185; B60Q 2400/50

(57) ABSTRACT

A vehicular road surface drawing device includes: a projection device that is provided in a vehicle having a driver's seat capable of adjusting a height with respect to a floor face, and that is configured to project an optical image on a road surface on which the vehicle is traveling so as to be situated in front of the vehicle in a traveling direction of the vehicle; and a control unit configured to control the projection device such that, when the height of the driver's seat with respect to the floor face becomes equal to or greater than a first threshold value, the distance in the traveling direction between the end portion on a traveling direction side of the optical image and the vehicle is shorter than when the height is less than the first threshold value.

### CROSS-REFERENCE TO RELATED APPLICATION

This application claims priority to Japanese Patent Application No. 2024-108374 filed on Jul. 4, 2024. The disclosure of the above-identified application, including the specification, drawings, and claims, is incorporated by reference herein in its entirety.

### BACKGROUND

### 1. Technical Field

The present disclosure relates to a vehicular road surface drawing device.

### 2. Description of Related Art

Japanese Unexamined Patent Application Publication No. 2021-079907 (JP 2021-079907 A) discloses a vehicular road surface drawing device that projects an optical image on a road surface on which a vehicle is traveling, for notifying people in the vicinity of the vehicle regarding a traveling direction of the vehicle.

### SUMMARY

The optical image that is projected on the road surface in JP 2021-079907 A may enter a field of view of a driver of the vehicle, depending on a projection position thereof. In this case, the driver may feel the optical image to be irksome, and drivability may deteriorate for the driver.

In view of the foregoing circumstances, an object of the present disclosure is to provide a vehicular road surface drawing device that is capable of projecting an optical image onto a road surface so as not to readily enter a field of view of a driver.

A vehicular road surface drawing device according to a first aspect includes a projection device that is provided in a vehicle including a driver's seat that is configured to adjust a height with respect to a floor face, and that projects an optical image on a road surface on which the vehicle is traveling so as to be situated in front of the vehicle in a traveling direction of the vehicle, and a control unit that controls the projection device such that, when the height of the driver's seat with respect to the floor face is no smaller than a first threshold value, a distance in the traveling direction between an end portion of the optical image on a traveling direction side and the vehicle becomes shorter than when the height is smaller than the first threshold value.

The vehicular road surface drawing device according to the first aspect includes the projection device that is provided in the vehicle having the driver's seat that is capable of adjusting the height thereof with respect to the floor face, and projects the optical image on the road surface on which the vehicle is traveling so as to be situated in front of the vehicle in the traveling direction of the vehicle. Further, the vehicular road surface drawing device of the first aspect includes the control unit that controls the projection device such that, when the height of the driver's seat with respect to the floor face is no smaller than the first threshold value, the distance in the traveling direction between the end portion of the optical image on the traveling direction side and the vehicle is shorter than when the height is smaller than the first threshold value. Accordingly, when the height of the driver's seat with respect to the floor face is no smaller than the first threshold value, the optical image projected on the road surface does not readily enter the field of view of the driver, as compared with a case in which the distance in the traveling direction between the end portion of the optical image on the traveling direction side and the vehicle is constant, regardless of the height of the driver's seat with respect to the floor face.

With the vehicular road surface drawing device according to a second aspect, in the first aspect, the control unit controls the projection device such that a dimension of the optical image in the traveling direction when the height of the driver's seat is no smaller than the first threshold is shorter than a dimension when the height is smaller than the first threshold value.

In the second aspect, the dimension of the optical image in the traveling direction when the height of the driver's seat is no smaller than the first threshold value is shorter as compared to the dimension when the height is smaller than the first threshold value. Accordingly, when the height of the driver's seat with respect to the floor face is no smaller than the first threshold value, the optical image that is projected on the road surface does not readily enter the field of view of the driver.

With the vehicular road surface drawing device according to a third aspect, in the second aspect, a shape of the optical image, when the height of the driver's seat is no smaller than the first threshold value, is a shape in which the entire optical image, when the height is smaller than the first threshold value, is reduced in the traveling direction.

In the third aspect, the shape of the optical image when the height of the driver's seat is no smaller than the first threshold value is a shape obtained by reducing the entire optical image in the traveling direction when the height of the driver's seat is smaller than the first threshold value. Accordingly, the shape of the optical image when the height of the driver's seat is no smaller than the first threshold value and the shape of the optical image when the height is smaller than the first threshold value can be made to be the same, except for the dimensions thereof.

With the vehicular road surface drawing device according to a fourth aspect, in the third aspect, the vehicular road surface drawing device includes an angle adjustment device for adjusting an angle of the projection device with respect to a horizontal direction in a side view of the vehicle.

In the vehicular road surface drawing device of the fourth aspect, the shape of the optical image when the height of the driver's seat is no smaller than the first threshold value can be a shape obtained by reducing the entire optical image in the traveling direction when the height of the driver's seat is smaller than the first threshold value. Further, adjusting the angle of the projection device enables the dimensions of the entire optical image to be changed.

With the vehicular road surface drawing device according to a fifth aspect, in the second aspect, a shape of the optical image when the height of the driver's seat is no smaller than the first threshold value is a shape in which part of the optical image, when the height is smaller than the first threshold value, is omitted.

According to the fifth aspect, for the optical image that is projected on the road surface can be kept from readily entering the field of view of the driver, while simplifying a configuration of the vehicular road surface drawing device.

As described above, the vehicular road surface drawing device according to the present disclosure has an excellent effect that the optical image can be projected onto the road surface so as not to readily enter the field of view of the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a vehicle and a road including a vehicular road surface drawing device according to an embodiment;

FIG. 2 is a schematic cross-sectional view when viewed from the side of the vehicular road surface drawing device;

FIG. 3 is a schematic front view of a shade that is a component of a vehicular road surface drawing device;

FIG. 4 is a control diagram of an ECU of vehicles;

FIG. 5 is a functional diagram of ECU shown in FIG. 4;

FIG. 6 is a schematic plan view of a road and a vehicle when a first drawing image is rendered on a road in a first mode;

FIG. 7 is a schematic plan view of a road and a vehicle when a third drawing image is drawn on a road in a first mode;

FIG. 8 is a schematic side view of a vehicle and a road when the first drawing image is rendered on the road in the second mode;

FIG. 9 is a schematic plan view of a road and a vehicle when a first drawing image is drawn on a road in a second mode;

FIG. 10 is a schematic plan view of a road and a vehicle when a third drawing image is drawn on a road in a second mode;

FIG. 11 is a flow chart illustrating a process executed by CPU of ECU;

FIG. 12 is a schematic side view of vehicles and roads when the third drawing images of the first modification are drawn on the roads in the second mode; and

FIG. 13 is a schematic side view of a vehicle and a road when the first drawing image of the second modification is rendered on the road in the third mode.

### DETAILED DESCRIPTION OF EMBODIMENTS

Hereinafter, an embodiment of a vehicular road surface drawing device according to the present disclosure will be described with reference to the accompanying drawings. Note that the arrows UP, the arrow FR, and the arrow LH in the drawings respectively indicate the upper side in the vehicle up-down direction, the front side in the vehicle front-rear direction, and the left side in the vehicle widthwise direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

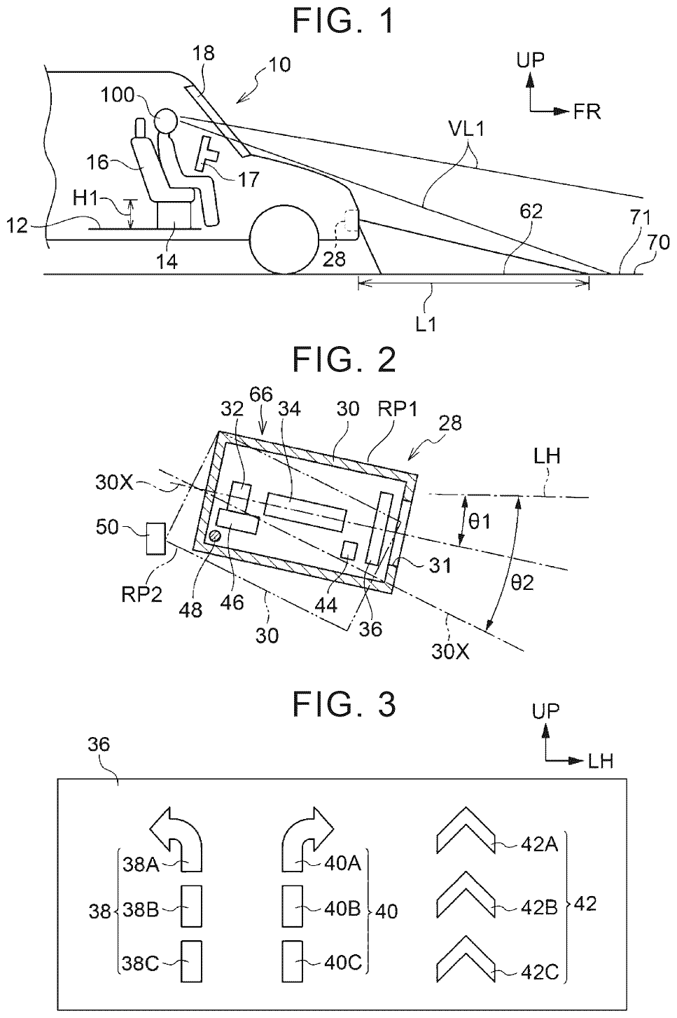

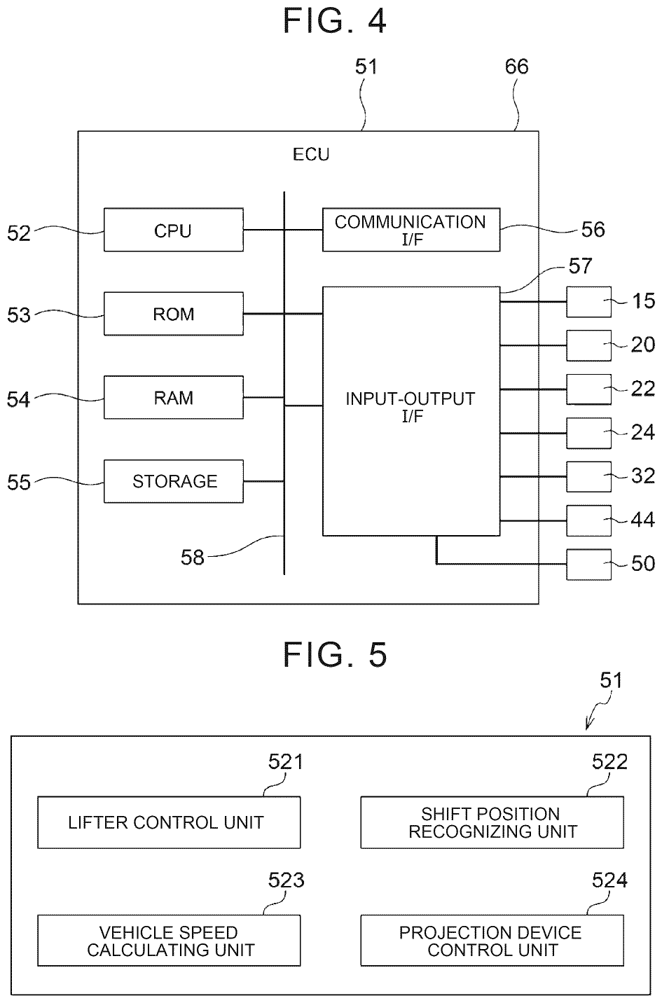

As shown in FIG. 1, a driver's seat 16 is provided via an electric lifter device 14 on a floor face 12 constituting a bottom surface of a vehicle cabin of a vehicle 10 to which a vehicular road surface drawing device 66 (hereinafter, referred to as a drawing device 66) according to the present embodiment is applied. That is, the driver's seat 16 is positioned immediately behind the steering wheel 17 provided in an instrument panel (not shown) of the vehicle 10. The lifter device 14 is operated by the action of the first electric motor 15 (see FIG. 4). The driver's seat 16 is raised and lowered with respect to the floor face 12 by the action of the lifter device 14. The height of the driver's seat 16 (the lower surface of the seat portion) shown in FIG. 1 from the floor face 12 is H1. The height of the driver's seat 16 (seat portion) shown in FIG. 8 from the floor face 12 is H2 and H2>H1.

The vehicle body of the vehicle 10 is provided with a front windshield 18. Therefore, the driver 100 seated on the driver's seat 16 can visually recognize the scene ahead of the front windshield 18 through the front windshield 18. The vehicle 10 is provided with four wheel speed sensors 20 (see FIG. 4) for detecting the respective wheel speeds of the four wheels.

The vehicle 10 includes a winker lever (not shown). The winker lever is movable (rotated) from a neutral position (initial position) to a first position below the neutral position and a second position above the neutral position. Further, the vehicle 10 25 includes a lever position detection sensor 22 (see FIG. 4) capable of detecting the position of the turn-in car lever. When the lever position detection sensor 22 detects that the winker lever is in the first position, the right direction indicator (luminaire) provided at the front end portion of the vehicle 10 is turned on. When the lever position detection sensor 22 detects that the winker lever is in the second position, a left direction indicator (luminaire) provided 30 at a front end portion of the vehicle 10 is turned on.

The vehicle 10 includes a shift lever (not shown). The shift lever is movable to the shift positions of the P range (parking range), the R range (reverse range), the N range (neutral range), and the D range (drive range). The vehicle 10 further includes a shift position sensor 24 that repeatedly acquires the shift position of the shift lever at a predetermined cycle (scc FIG. 4).

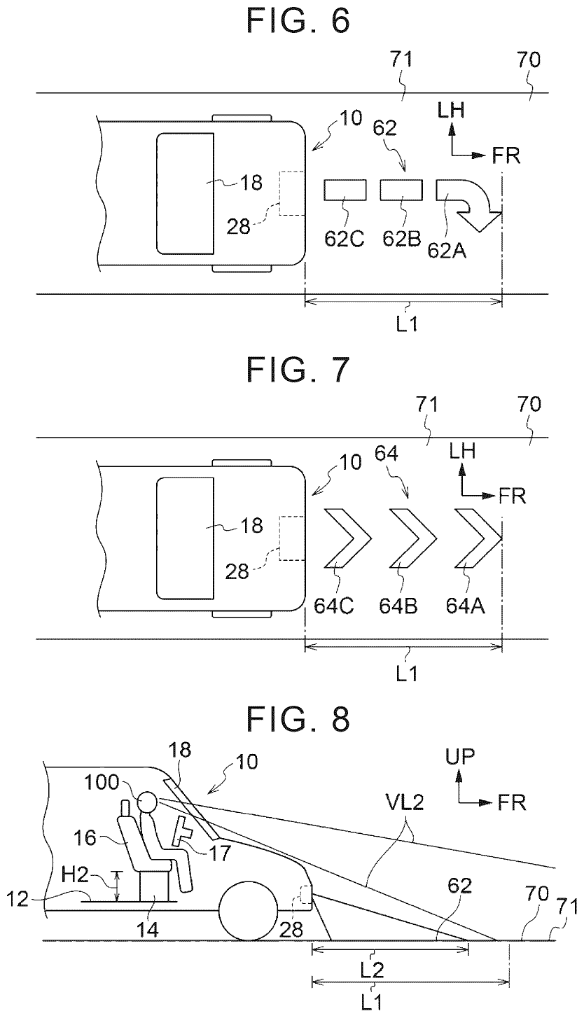

As shown in FIGS. 1 and 6, a projection device 28 is provided at a front end portion of the vehicle 10. As illustrated in FIG. 2, the projection device 28 includes a case 30, a light source 32, an optical system 34, a shade 36, a second electric motor 44, a heat sink 46, a rotation center shaft (angle adjustment device) 48, and a third electric motor (angle adjustment device) 50. The light source 32, the optical system 34, the second electric motor 44, and the heat sink 46 located inside the case 30 are fixed to the case 30. Further, an opening 31 is formed in a front end portion of the case 30. The optical system 34 is positioned immediately before the light source 32. Further, a shade 36 positioned immediately before the optical system 34 and movable in the left-right direction with respect to the case 30 is provided inside the case 30.

As shown in FIG. 3, the shade 36 is a flat plate made of metal having a rectangular front shape. In the shade 36, a first forming hole 38, a second forming hole 40, and a third forming hole 42 are formed as through holes. The first forming hole 38 formed in the right part of the shade 36 includes a first component 38A, a second component 38B, and a third component 38C arranged vertically and separated from each other. The first component 38A is arrow-shaped. The second component 38B and the third component 38C are substantially rectangular. The second forming hole 40 formed in the central portion of the shade 36 has a first component 40A, a second component 40B, and a third component 40C that are vertically aligned and separated from each other. The first forming hole 38 and the second forming hole 40 are symmetrical to each other. The third forming hole 42 formed in the left part of the shade 36 has a first component 42A, a second component 42B, and a third component 42C arranged vertically and separated from each other. The first component 42A, the second component 42B, and the third component 42C are V-shaped in the same configuration.

The shade 36 is movable to a first drawing position, a second drawing position on the right side of the initial position, and a third drawing position on the right side of the second drawing position by the driving force of the second electric motor 44. When the shade 36 is in the first drawing position, the first forming hole 38 is positioned immediately before the optical system 34. When the shade 36 is in the second drawing position, the second forming hole 40 is positioned immediately before the optical system 34. When the shade 36 is in the third drawing position, the third forming hole 42 is positioned immediately before the optical system 34.

The heat sink 46 has a function of cooling the light source 32.

The case 30 is rotatably supported at a front portion of the vehicle body by a rotation center shaft 48 provided at a rear portion of the case 30 and extending in the left-right direction. Further, the case 30 (the projection device 28) is rotatable about the rotation center shaft 48 by the driving force of the third electric motor 50 provided in the front portion of the vehicle 10. Therefore, the case 30 is rotatable between a first rotational position RP1 indicated by a solid line in FIG. 2 and a second rotational position RP2 indicated by an imaginary line in FIG. 2. When the case 30 is in the first rotational position RP1, the axial line 30X of the case 30 passing through the opening 31, the light source 32, the optical system 34, and the shade 36 is positioned lower than the horizontal line HL in the side view, and the angle formed by the horizontal line HL and the axial line 30X is θ1. When the case 30 is in the second rotational position RP2, the axial line 30X is positioned below the horizontal line HL in a side view, and an angle formed by the horizontal line HL and the axial line 30X is θ2 larger than θ1.

Vehicle 10 comprises ECU (Electronic Control Unit) 51 shown in FIG. 4. ECU 51 includes a CPU (Central Processing Unit (processor)) (control unit) 52, a ROM (Read Only Memory) 53, a RAM (Random Access Memory) 54, a storage 55, a communication I/F (Interface) 56, and an input/output I/F 57. CPU 52, ROM 53, RAM 54, the storage 55, the communication I/F 56, and the input/output I/F 57 are communicably connected to each other via a bus 58. ECU 51 can acquire date and time information from a timer (not shown).

CPU 52 is a central processing unit that executes various programs and controls cach unit. That is, CPU 52 reads the program from ROM 53 or the storage 55, and executes the program using RAM 54 as a working area. CPU 52 performs control of respective configurations and various arithmetic processes (information processing) in accordance with programs recorded in ROM 53 or the storage 55.

ROM 53 stores various programs and various data. The RAM 54 temporarily stores a program or data as a work area. The storage 55 is constituted by a storage device such as an HDD (Hard Disk Drive) or an SSD (Solid State Drive), and stores various programs and various data. The communication I/F 56 is an interface capable of communicating with a device located outside the vehicles 10. As the communication I/F 56, a communication standard such as Bluetooth (registered trademark) or Wi-Fi (registered trademark) is used. Further, the communication I/F 56 can communicate with an ECU different from ECU 51 provided in the vehicles 10 via an external bus. The input/output I/F 57 is an interface for communicating with various devices. For example, a first electric motor 15, a wheel speed sensor 20, a lever position detection sensor 22, a shift position sensor 24, a light source 32, a second electric motor 44, and a third electric motor 50 are connected to the input/output I/F 57.

As illustrated in FIG. 5, ECU 51 includes a lifter control unit 521, a shift-position recognizing unit 522, a vehicle speed calculating unit 523, and a projection device control unit 524 as a functional configuration. The lifter control unit 521, the shift-position recognizing unit 522, the vehicle speed calculating unit 523, and the projection device control unit 524 are realized by CPU 52 reading out and executing a program stored in ROM 53.

The lifter control unit 521 controls the lifter device 14 while supplying electric power of a battery (not shown) mounted on the vehicle 10 to the first electric motor 15 when a lifter operation switch (not shown) provided on the instrument panel is operated. The height of the driver's seat 16 from the floor face 12, which is calculated based on the amount of operation of the first electric motor 15, is recorded in the storage 55. The lifter control unit 521 acquires information on the height at the current time from the storage 55, and determines whether the height is equal to or greater than the first threshold value. The first threshold value are recorded in ROM 53. The height H1 in FIG. 1 is less than the first threshold value, and the height H2 in FIG. 8 is greater than or equal to the first threshold value.

The shift position recognizing unit 522 recognizes the shift position based on the signal received from the shift position sensor 24.

The vehicle speed calculating unit 523 calculates the vehicle speed of the vehicle 10 based on the detection values of the respective wheel speed sensors 20.

The projection device control unit 524 supplies the power of the battery to the projection device 28 to control the projection device 28 when a predetermined drawing condition is satisfied. For example, when the projection device control unit 524 determines that the winker lever is at the first position or the second position based on the signal received from the lever position detection sensor 22, the first drawing condition, which is one of the drawing conditions, is satisfied. Further, for example, when it is determined that the shift lever is in the D range and it is determined that the vehicle speed of the vehicle 10 has changed from zero to a vehicle speed equal to or higher than a predetermined value, the second drawing condition, which is one of the drawing conditions, is satisfied.

When the drawing condition is satisfied, the projection device control unit 524 turns on the light source 32 for a predetermined period of time. Further, when the first drawing condition is satisfied when the winker lever is in the first position, the projection device control unit 524 controls the second electric motor 44 to position the shade 36 at the first drawing position. Therefore, the light beam emitted forward from the light source 32 and transmitted through the optical system 34 is supplied to the portion where the first forming hole 38 of the shade 36 is formed. Therefore, the light flux passing through the first forming hole 38 and the opening 31 is emitted toward the front of the vehicle 10. When the first drawing condition is satisfied when the winker lever is in the second position, the projection device control unit 524 controls the second electric motor 44 to position the shade 36 at the second drawing position. Therefore, the light beam emitted forward from the light source 32 and transmitted through the optical system 34 is supplied to the portion where the second forming hole 40 of the shade 36 is formed. Therefore, the light flux passing through the second forming hole 40 and the opening 31 is emitted toward the front of the vehicle 10. When the second drawing condition is satisfied, the projection device control unit 524 controls the second electric motor 44 to position the shade 36 at the third drawing position. Therefore, the light beam emitted forward from the light source 32 and transmitted through the optical system 34 is supplied to the portion where the third forming hole 42 of the shade 36 is formed. Therefore, the light flux passing through the third forming hole 42 and the opening 31 is emitted toward the front of the vehicle 10.

Further, when the lifter control unit 521 determines that the height of the driver's seat 16 from the floor face 12 is less than the first threshold value, the projection device control unit 524 controls the third electric motor 50 to set the rotational position of the case 30 to the first rotational position RP1. Therefore, as shown in FIG. 1, an optical image is projected in the first mode onto the road surface 71 of the road 70 on which the vehicle 10 is traveling. For example, when the shade 36 is at the first drawing position, the first drawing image (optical image) 62 is projected on the road surface 71 as illustrated in FIGS. 1 and 6. The first drawing images 62 include a first component 62A generated by the first component 38A, a second component 62B generated by the second component 38B, and a third component 62C generated by the third component 38C. The first drawing image 62 is projected onto a portion of the road surface 71 located in front of the front end of the vehicle 10. Further, the front-rear distance in a plan view between the front end of the first drawing images 62 (first component 62A) and the front end of the vehicles 10 is the first distance L1. Hereinafter, the distance in the front-rear direction in a plan view between the front end of the optical image on the road surface 71 and the front end of the vehicle 10 is referred to as a specific distance. A person (not shown) who is located in the vicinity of the road 70 and who views the first drawing image 62 projected on the road surface 71 can recognize that the vehicle 10 is scheduled to turn right.

Further, when the shade 36 is at the second drawing position, the projection device control unit 524 sometimes determines that the height of the driver's seat 16 from the floor face 12 is less than the first threshold value. At this time, a second drawing image (not shown) generated by the second forming hole 40 is projected onto the road surface 71 in the first mode. The second drawing images include a first component generated by the first component 40A, a second component generated by the second component 40B, and a third component generated by the third component 40C. The second drawing image is projected onto a portion of the road surface 71 located in front of the front end of the vehicle 10. Furthermore, the second drawing images and the specified distance of the vehicles 10 are the first distance L1. A person who is located in the vicinity of the road 70 and views the second drawing image projected on the road surface 71 can recognize that the vehicle 10 is scheduled to turn left.

Further, when the shade 36 is at the third drawing position, the projection device control unit 524 sometimes determines that the height of the driver's seat 16 from the floor face 12 is less than the first threshold value. At this time, as shown in FIG. 7, the third drawing image (optical image) 64 generated by the third forming hole 42 is projected onto the road surface 71 in the first mode. The third drawing images 64 include a first component 64A generated by the first component 42A, a second component 64B generated by the second component 42B, and a third component 64C generated by the third component 42C. The third drawing image 64 is projected onto a portion of the road surface 71 located in front of the front end of the vehicle 10. Furthermore, the third drawing images 64 and the specified distance of the vehicles 10 are the first distance L1. A person who is located in the vicinity of the road 70 and views the third drawing image 64 projected on the road surface 71 can recognize that the stopped vehicle 10 has started traveling forward.

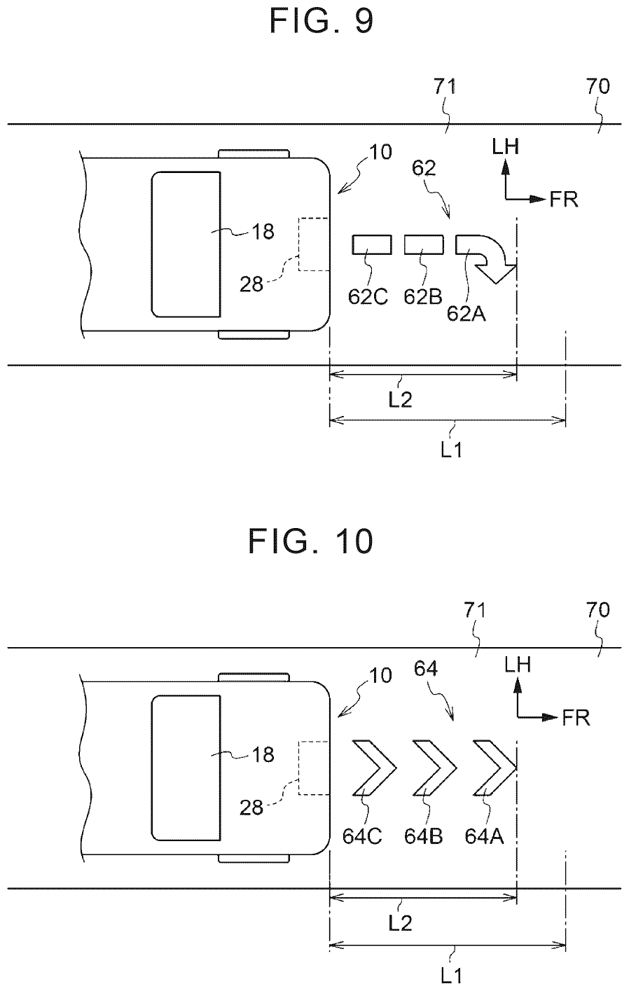

Further, when the lifter control unit 521 determines that the height of the driver's seat 16 from the floor face 12 is equal to or greater than the first threshold value, the projection device control unit 524 controls the third electric motor 50 to set the rotational position of the case 30 to the second rotational position RP2. Therefore, as shown in FIG. 8, an optical image is projected in the second mode onto the road surface 71 of the road 70 on which the vehicle 10 is traveling. For example, when the shade 36 is at the first drawing position, the first drawing image 62 is projected on the road surface 71 as illustrated in FIGS. 8 and 9. However, the specified distance between the first drawing images 62 and the vehicles 10 is a second distance L2 shorter than the first distance L1. That is, since the rotational position of the case 30 is set to the second rotational position RP2, the total length (front-rear dimension) of the first drawing image 62 in this case is shorter than the total length (front-rear dimension) of the first drawing image 62 when the rotational position of the case 30 is set to the first rotational position RP1. That is, the shape of the optical image projected onto the road surface 71 in the second mode is a shape obtained by reducing the entire optical image projected onto the road surface 71 in the first mode in the traveling direction.

When the rotational position of the case 30 is set to the second rotational position RP2 when the shade 36 is at the second drawing position, the second drawing images are projected onto the road surface 71 in the second mode. The second drawing images and the specified distance of the vehicles 10 are the second distance L2. That is, the total length of the second drawing image in this case is shorter than the total length of the second drawing image when the rotational position of the case 30 is set to the first rotational position RP1.

When the rotational position of the case 30 is set to the second rotational position RP2 when the shade 36 is at the third drawing position, the third drawing images 64 are projected onto the road surface 71 in the second mode as shown in FIG. 10. The specified distance between the third drawing images 64 and the vehicles 10 is the second distance L2. That is, the total length of the third drawing image 64 in this case is shorter than the total length of the third drawing image 64 when the rotational position of the case 30 is set to the first rotational position RP1.

Among the configurations described above, the projection device 28 and ECU 51 are components of the drawing device 66.

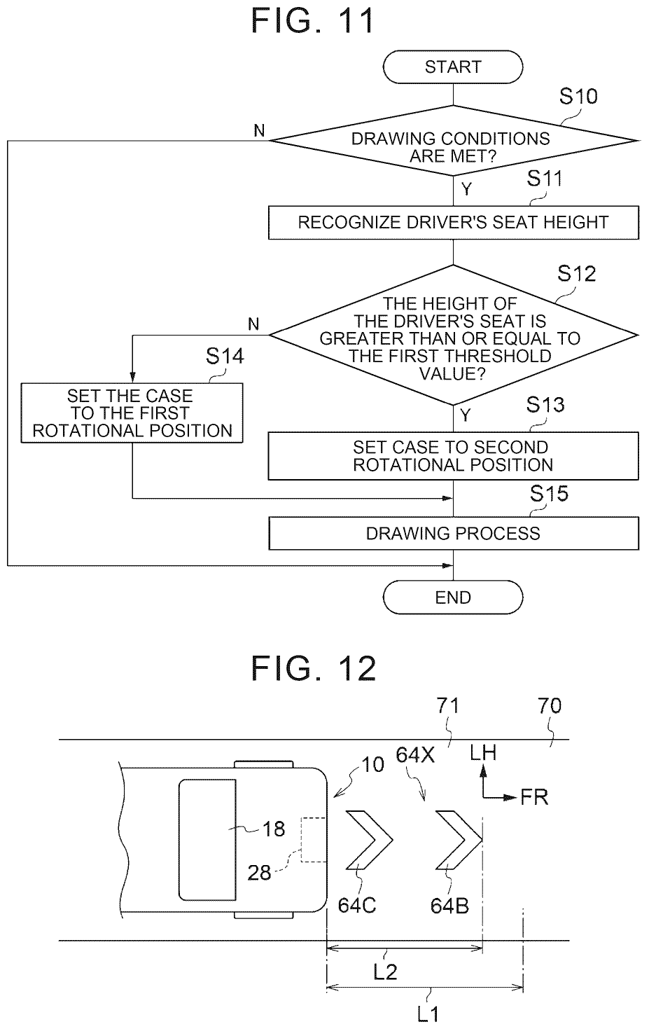

Next, a process executed by CPU 52 of ECU 51 will be described. CPU 52 repeatedly executes the process of the flow chart shown in FIG. 11 every time a predetermined period elapses.

In S10 (hereinafter, the characters of the steps are omitted), CPU 52 determines whether or not the drawing condition is satisfied.

When S10 determines Yes, CPU 52 proceeds to S11 and recognizes the height of the driver's seat 16.

In a CPU 52 where S11 process is completed, the process proceeds to S12, and it is determined whether or not the height of the driver's seat 16 is equal to or greater than the first threshold value.

When it is determined in S12 that it is Yes, CPU 52 proceeds to S13 and sets the rotational position of the case 30 of the projection device 28 to the second rotational position RP2.

When No is determined in S12, CPU 52 proceeds to S14 and sets the rotational position of the case 30 to the first rotational position RP1.

In a CPU 52 where S13 or S14 process is completed, the process proceeds to S15, and a drawing process is executed in which the light source 32 is turned on and the shade 36 is positioned at a predetermined position. As a result, one drawing image (optical image) is projected onto the road surface 71 of the road 70.

When it is determined that S10 is No or when S15 process is completed, CPU 52 temporarily ends the process of the flow chart of FIG. 11.

As described above, the drawing device 66 of the present embodiment includes the projection device 28 that projects the optical image (the first drawing image 62, the second drawing image, and the third drawing image 64) located on the traveling direction side of the vehicle 10 on the road surface 71 on which the vehicle 10 is traveling. The height of the driver's seat 16 relative to the floor face 12 may be greater than or equal to a first threshold value. At this time, the drawing device 66 further includes a CPU 52 for controlling the projection device 28 so that the optical image on the road surface 71 and the specific distance (the second distance L2) of the vehicles 10 are shorter than the specific distance (the first distance L1) when the height is less than the first threshold value.

As shown in FIG. 1, when the height H1 of the driver's seat 16 is less than the first threshold value, the driver 100 can visually recognize the front area of the vehicle 10 through the front windshield 18. The field of view of the driver 100 at this time is the area between the two straight line VL1 depicted in FIG. 1. Therefore, when the optical image (the first drawing image 62, the second drawing image, and the third drawing image 64) is projected onto the road surface 71 in the first mode, it is difficult for the optical image to enter the field of view of the driver 100. Therefore, in this case, the driver 100 is less likely to feel the optical image on the road surface 71 troublesome. That is, in this case, there is a small possibility that the drivability of the driver 100 is deteriorated by the optical image on the road surface 71.

As illustrated in FIG. 8, even when the height H2 of the driver's seat 16 is equal to or greater than the first threshold value, the driver 100 can visually recognize the front area of the vehicle 10 through the front windshield 18. The field of view of the driver 100 at this time is the area between the two straight line VL2 depicted in FIG. 8. Therefore, when the optical image is projected on the road surface 71 in the first mode, there is a high possibility that the optical image enters the field of view of the driver 100. However, since the optical image is projected onto the road surface 71 in the second mode when the height of the driver's seat 16 is equal to or greater than the first threshold value, it is difficult for the optical image to enter the field of view of the driver 100. Therefore, in this case as well, the driver 100 is less likely to feel the optical image on the road surface 71 troublesome.

Further, the drawing device 66 controls the projection device 28 so that the shape of the optical image when the height of the driver's seat 16 becomes equal to or greater than the first threshold value is a shape obtained by reducing the entire optical image in the traveling direction when the height becomes less than the first threshold value. Therefore, the shape of the optical image when the height of the driver's seat 16 becomes equal to or greater than the first threshold value and the shape of the optical image when the height is less than the first threshold value can be made the same except for the dimensions. Therefore, even when the optical image on the road surface 71 has an asymmetrical shape like the first drawing image 62, the optical image can be formed on the road surface 71 in the second mode.

Further, the drawing device 66 can freely change the size of the entire optical image on the road surface 71 by adjusting the angle of the projection device 28.

Although the vehicular road surface drawing device according to the embodiment has been described above, these can be appropriately changed in design without departing from the gist of the present disclosure.

For example, the disclosure may be implemented in the manner of the first variant shown in FIG. 12. For example, a third forming hole (not shown) having only the second component 42B and the third component 42C is formed in the shade 36, and the height of the driver's seat 16 may be equal to or greater than the first threshold value. At this time, while the rotational position of the case 30 is maintained at the first rotational position RP1, the light emitted from the light source 32 may be irradiated onto the portion of the shade 36 where the third forming hole is formed. In this case, as shown in FIG. 12, the third drawing image 64X having only the second component 64B and the third component 64C is projected onto the road surface 71. The third drawing image 64X is the same as the optical image obtained by removing the first component 64A from the third drawing image 64 projected in the first mode. Again, the specified distance between the third drawing images 64X and the vehicles 10 is the second distance L2. Note that the drawing device 66 of the first modification may not include the rotation center shaft 48 and the third electric motor 50.

When the optical image on the road surface 71 and the specified distance of the vehicle 10 are changed to the second distance L2 by using the rotation center shaft 48 and the third electric motor 50 as in the embodiment, the rotation control of the third electric motor 50 needs to be performed with high accuracy. On the other hand, when the light of the light source 32 is irradiated to the third forming hole formed in the shade 36 as in the first modification, the forming accuracy of the third forming hole in the shade 36 and the control accuracy of the second electric motor 44 need not be so high. Therefore, the drawing device 66 of the first modification can be manufactured at low cost.

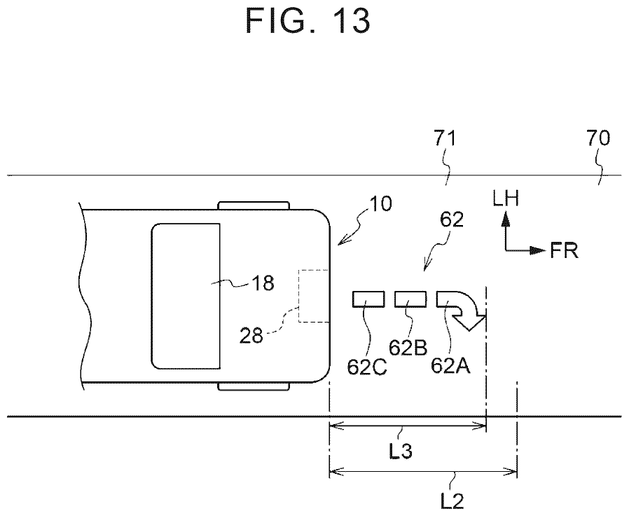

For example, the present disclosure may be implemented in the manner of the second variation shown in FIG. 13. In the second modification, when the height of the driver's seat 16 from the floor face 12 is equal to or greater than the second threshold value which is a predetermined value larger than the first threshold value, the optical image is projected onto the road surface 71 in the third mode by making the rotational position of the case 30 with respect to the horizontal line HL larger than the second rotational position RP2. Here, the optical image projected on the road surface 71 and the specified distance of the vehicles 10 become a third distance L3 shorter than the second distance L2. For example, as shown in FIG. 13, the first drawing image 62 is rendered on the road surface 71 in the third mode. Therefore, even when the height of the driver's seat 16 from the floor face 12 becomes equal to or higher than the second threshold value, it is difficult for the optical image to enter the field of view of the driver 100. Note that, for example, by forming a third forming hole (not shown) having only the third component portion in the shade 36, the optical image may be projected onto the road surface 71 so that a specified distance between the optical image and the vehicle 10 is the third distance L3.

A variable magnification optical system having a plurality of movable lenses may be disposed between the shade 36 and the opening 31 of the case 30, and the variable magnification ratio of the variable magnification optical system may be changed in accordance with the height of the driver's seat 16 from the floor face 12. Again, the optical image and the specific distance of the vehicle 10 when the height from the floor face 12 of the driver's seat 16 is less than the first threshold value can be shorter than the optical image on the road surface 71 and the specific distance of the vehicle 10 when the height is greater than or equal to the first threshold value. Further, the optical image in the case where the height of the driver's seat 16 is equal to or greater than the first threshold value and less than the second threshold value and the specific distance of the vehicle 10 can be made shorter than the optical image in the case where the height is equal to or greater than the second threshold value and the specific distance of the vehicle 10.

When the height of the driver's seat 16 from the floor face 12 becomes equal to or greater than the first threshold value, the projection device 28 may be controlled so that the optical image on the road surface 71 and the specific distance of the vehicle 10 gradually become shorter as the height increases.

The projection device 28 may comprise a number of light sources corresponding to the number of forming holes provided in the shade 36. For example, in a case where the first forming hole 38, the second forming hole 40, and the third forming hole 42 are formed in the shade 36, the projection device 28 may include three light sources positioned immediately after each of the first forming hole 38, the second forming hole 40, and the third forming hole 42. In this case, only one light source is turned on, and an optical image generated by a hole formed immediately before the turned-on light source is projected onto the road surface 71.

The projection device 28 may include a number of light sources corresponding to each component of each forming hole. For example, when only the first forming hole 38 is formed in the shade 36, the projection device 28 may include three light sources positioned immediately before each of the first component 38A, the second component 38B, and the third component 38C. In this case, the optical image generated by the component corresponding to the lighted light source is projected onto the road surface 71. For example, when only two light sources located immediately after the first component 10 38A are turned on, the third drawing image 64X is projected onto the road surface 71 as shown in FIG. 12.

The shape (type) of the optical image projected on the road surface may be different from those of the above-described embodiment and each modification example. For example, the optical image may have only a single site (e.g., the first component 62A).

What is claimed is:

1. A vehicular road surface drawing device, comprising:
a projection device that is provided in a vehicle including a driver's seat that is configured to adjust a height with respect to a floor face, and that projects an optical image on a road surface on which the vehicle is traveling so as to be situated in front of the vehicle in a traveling direction of the vehicle; and
a control unit that controls the projection device such that, when the height of the driver's seat with respect to the floor face is no smaller than a first threshold value, a distance in the traveling direction between an end portion of the optical image on a traveling direction side and the vehicle becomes shorter than when the height is smaller than the first threshold value.

2. The vehicular road surface drawing device according to claim 1, wherein the control unit controls the projection device such that a dimension of the optical image in the traveling direction when the height of the driver's seat is no smaller than the first threshold value is shorter than a dimension when the height is smaller than the first threshold value.

3. The vehicular road surface drawing device according to claim 2, wherein a shape of the optical image, when the height of the driver's seat is no smaller than the first threshold value, is a shape in which an entire optical image, when the height is smaller than the first threshold value, is reduced in the traveling direction.

4. The vehicular road surface drawing device according to claim 3, further comprising an angle adjustment device that adjusts an angle of the projection device with respect to a horizontal direction, in a side view of the vehicle.

5. The vehicular road surface drawing device according to claim 2, wherein a shape of the optical image when the height of the driver's seat is no smaller than the first threshold value is a shape in which part of the optical image, when the height is smaller than the first threshold value, is omitted.
